(19) United States
(12) Patent Application Publication
(10) Pub. No.: US 2010/0214488 A1
(43) Pub. Date: Aug. 26, 2010

(54) IMAGE SIGNAL PROCESSING DEVICE

(75) Inventors: Tomohisa Higuchi, Chuo-ku (JP); Yoshinori Takao, Chuo-ku (JP)

Correspondence Address: SUGHRUE MION, PLLC, 2100 PENNSYLVANIA AVENUE, N.W., SUITE 800, WASHINGTON, DC, 20037, US

(73) Assignee: Thine Electronics, Inc., Chiyoda-ku, Tokyo (JP)

(21) Appl. No.: 12/672,218

(22) PCT Filed: Aug. 5, 2008
(86) PCT No.: PCT/JP2008/064055

§ 371 Date: Apr. 22, 2010

(30) Foreign Application Priority Data
Aug. 6, 2007 (JP) 2007-204292

(51) Int. Cl. H04N 5/14

(52) U.S. Cl. 348/699; 348/E05.062

(57) ABSTRACT

An image signal processing device 1 comprises a delay part 10, a motion detection part 20, an intermediate frame generation part 30 and an output part 40. The motion detection part 20 detects a motion of an image of a second frame with respect to an image of a first frame based on image data G₁ of the first frame to be output from the delay part 20 and image data G₂ of the second frame to be input to the delay part 20. The intermediate frame generation part 30 generates image data G_{C} of an intermediate frame based on the image data G₁ and G₂ of the first frame and the second frame, respectively. An edge in the image of the intermediate frame is located between edges in the images of the first frame and the second frame, respectively. The output part 40 inserts the image data G_{C} of the intermediate frame before the image data G₂ of the second frame and outputs the data.

### TECHNICAL FIELD

The present invention relates to an image signal processing device that outputs an image signal to a liquid crystal display device after processing image data of each frame of the image signal.

### BACKGROUND ART

An image display device is roughly classified into an impulse type display device and a hold type display device. In a CRT (Cathode Ray Tube) mentioned of as an example of an impulse type display device, a screen is scanned by an electron gun and a display is produced only in pixels that electron beams have reached. In contrast to this, in a liquid crystal display device (LCD) or an organic electroluminescence (EL) display device mentioned of as a hold type display device, a frame of an image signal is updated at a fixed period and when a display of an image of a certain first frame is specified, the display of the image of the first frame is held until a display of an image of a second frame that follows is specified. Compared to an impulse type display device, a hold type display device has various characteristics, such as that image distortion is unlikely to occur.

However, a liquid crystal display device has a problem that response is slow. That is, it takes time for an actual display value in a liquid crystal display device to reach a target display value after the target display value of an image of a certain frame is specified. There may be a case where the required time exceeds a period at which a frame is updated. Consequently, when a motion picture in which images change rapidly is displayed on the screen of a liquid crystal display device, there may be a case where blur appears in the motion picture.

As a technique intended to solve such a problem, the overdrive technique is publicly known (refer to patent documents 1, 2).

According to the overdrive technique, when a certain pixel on the screen of a liquid crystal display device is focused on, if image data G₂ corresponding to a target display value in the next second frame is different from image data G₁ corresponding to a target display value in a certain first frame, the image data G₂ is corrected and then, corrected image data G₂′ is given to the liquid crystal display device. At the time of the correction, when “G₁<G₂”, G₂ is corrected so that “G₂<G₂′” and when “G₁>G₂”, then G₂ is corrected so that “G₂>G₂′”. By providing an image signal processing device that outputs an image signal to a liquid crystal display device after processing image data of each frame of the image signal as described above, it is made possible for the actual display value to reach the target display value quickly in the liquid crystal display device.

Patent document 1: Japanese Unexamined Patent Publication (Kokai) No. 2005-043864

Patent document 2: Japanese Unexamined Patent Publication (Kokai) No. 2006-091412

### DISCLOSURE OF THE INVENTION

By correcting image data of each frame of an image signal using the overdrive technique described above, a problem that the response of a liquid crystal display device is slow can be solved, however, a liquid crystal display device is a hold-type image device, and therefore, there is also a problem that results from the visual characteristics of a viewer who is watching a motion picture that is displayed. That is, in a liquid crystal display device, a display of an image of each frame is maintained through a period of time corresponding to one frame, however, the point on which a viewer of a motion picture focuses continuously moves in an attempt to follow the motion of the motion picture, and therefore, there may be a case where blur occurs in the image of the motion picture because of this.

A conventional image signal processing device employs the overdrive technique in order to solve the problem that the response of the liquid display device is slow, however, the problem resulting from the visual characteristics of a viewer who is watching a motion picture cannot be solved at the same time.

The present invention has been developed in order to solve the above-mentioned problems and an object thereof is to provide an image signal processing device capable of alleviating both the problem of the response speed of the liquid crystal display device and the problem of the visual characteristics.

An image signal processing device according to the present invention is an image signal processing device that outputs an image signal to a liquid crystal display device after processing image data of each frame of the image signal, the device comprising: (1) a delay part to which image data of each frame of an image signal is input, and which outputs the image data after delaying the image data by a period of time corresponding to one frame; (2) a motion detection part that detects a motion of an image of a second frame with respect to an image of a first frame based on the image data of the first frame to be output from the delay part and the image data of the second frame to be input to the delay part; (3) an intermediate frame generation part that generates image data of an intermediate frame based on the image data of the first frame and the second frame, respectively, when the motion detection part detects that an edge in the image of the second frame has moved a distance corresponding to two or more pixels with respect to an edge in the image of the first frame; and (4) an output part that inserts the image data of the intermediate frame before the image data of the second frame and outputs the data sequentially to the liquid crystal display device.

Further, in the image signal processing device according to the present invention, the intermediate frame generation part: (a) positions the edge in the image of the intermediate frame between the edges corresponding to each other in the images of the first frame and the second frame; respectively; (b) makes the image data of the intermediate frame larger than the image data of the second frame as to the pixel between the edge in the image of the intermediate frame and the edge in the image of the first frame when the image data of the second frame is larger than the image data of the first frame as to the pixel between the edge in the image of the first frame and the edge in the image of the second frame; and (c) makes the image data of the intermediate frame smaller than the image data of the second frame as to the pixel between the edge in the image of the intermediate frame and the edge in the image of the first frame when the image data of the second frame is smaller than the image data of the first frame as to the pixel between the edge in the image of the first frame and the edge in the image of the second frame.

In the image signal processing device according to the present invention, the image data of the first frame to be output from the delay part and the image data of the second frame to be input to the delay part are input to the motion detection part and the motion of the image of the second frame with respect to the image of the first frame is detected by the motion detection part. When the motion detection part detects that the edge in the image of the second frame has moved a distance corresponding to two or more pixels with respect to the edge in the image of the first frame, the intermediate frame generation part generates image data of an intermediate frame based on the image data of the first frame and the second frame, respectively. Then, the output part inserts the image data of the intermediate frame before the image data of the second frame and outputs the data sequentially to the liquid crystal display device.

The edge in the image of the intermediate frame generated in the intermediate frame generation part is located between the edges corresponding to each other in the images of the first frame and the second frame, respectively. When the image data of the second frame is larger than the image data of the first frame as to the pixel between the edge in the image of the first frame and the edge in the image of the second frame, the image data of the intermediate frame is made larger than the image data of the second frame as to the pixel between the edge in the image of the intermediate frame and the edge in the image of the first frame. Conversely, when the image data of the second frame is smaller than the image data of the first frame as to the pixel between the edge in the image of the first frame and the edge in the image of the second frame, the image data of the intermediate frame is made smaller than the image data of the second frame as to the pixel between the edge in the image of the intermediate frame and the edge in the image of the first frame.

Such an intermediate frame is generated by the intermediate frame generation part, the image data of the intermediate frame is inserted between the original first frame and the second frame, and the data is output to the liquid crystal display device. In the liquid crystal display device, a motion picture is displayed based on the image signal into which the image data of the intermediate frame is inserted.

In the image signal processing device according to the present invention, it is preferable for the intermediate frame generation part to make the image data of the intermediate frame to have a value between the image data of the first frame and the image data of the second frame as to the pixel between the edge in the image of the intermediate frame and the edge in the image of the second frame.

In the image signal processing device according to the present invention, it is preferable for the intermediate frame generation part to vary the image data of the intermediate frame in multiple steps between the edge in the image of the intermediate frame and the edge in the image of the first frame, or between the edge in the image of the intermediate frame and the edge in the image of the second frame when the motion detection part detects that the edge in the image of the second frame has moved a distance corresponding to three or more pixels with respect to the edge in the image of the first frame.

The above-mentioned processing may be performed for the entire image data of the frame, however, when only a partial region of the image to be displayed on the screen is a motion picture, the processing may be performed only for the image data corresponding to the partial region.

With the image signal processing device according to the present invention, it is possible to alleviate both the problem of the response speed of a liquid crystal display device and the problem of the visual characteristics.

### BRIEF DESCRIPTION OF THE DRAWINGS

FIG. 1 is a diagram showing a configuration of an image signal processing device 1 according to the present embodiment. FIG. 2 is a diagram for describing image data of an intermediate frame generated by an intermediate frame generation part 30 included in the image signal processing device 1 according to the present embodiment.

FIG. 3 is a diagram for describing image data of an intermediate frame generated by the intermediate frame generation part 30 included in the image signal processing device 1 according to the present embodiment.

FIG. 4 is a diagram showing image data of each frame of an image signal that is output from the image signal processing device 1 and input to a liquid crystal display device 2 according to the present embodiment.

FIG. 5 is a diagram for complementarily describing a movement of an image.

### DESCRIPTION OF THE REFERENCE SYMBOLS

1 image signal processing device
2 liquid crystal display device
10 delay part
20 motion detection part
30 intermediate frame generation part
40 output part

### BEST MODES FOR CARRYING OUT THE INVENTION

Preferred embodiments to embody the present invention are described below in detail with reference to the accompanied drawings. In the drawings, the same symbols are attached to the same components and duplicated description is omitted.

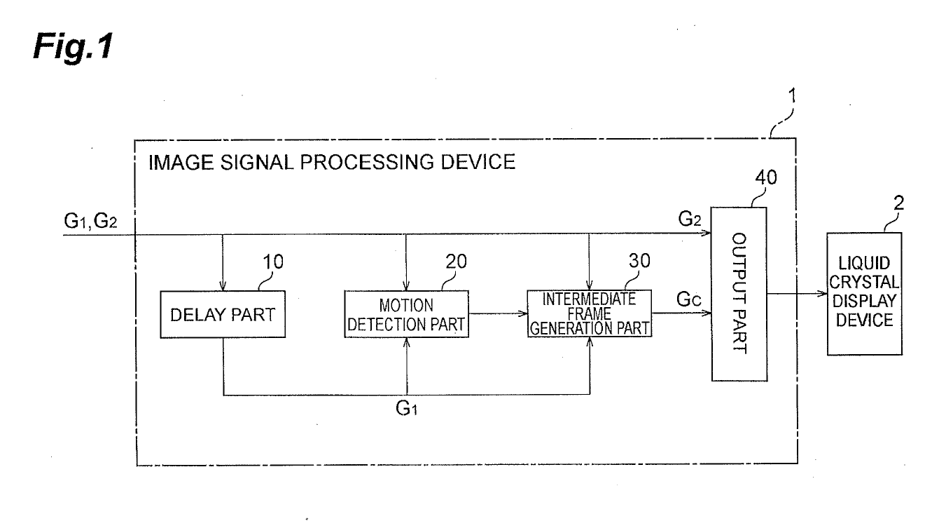

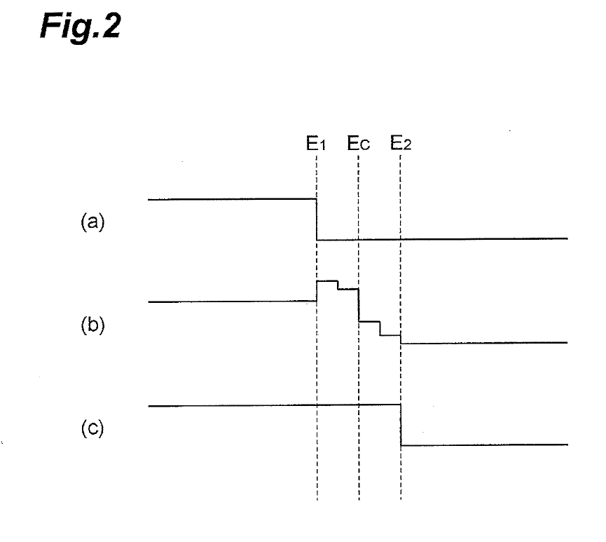

FIG. 1 is a diagram showing a configuration of an image signal processing device 1 according to the present embodiment. The image signal processing device 1 outputs an image signal to a liquid crystal display device 2 after processing image data of each frame of the image signal and comprises a delay part 10, a motion detection part 20, an intermediate frame generation part 30 and an output part 40. In the case of a color image, one color of the image data (luminance) is described below, however, the description also applies to the image data of the other colors.

To the delay part 10, image data of each frame of an image signal is input, and the delay part 10 delays the image data by a period of time corresponding to one frame and then outputs the image data to the motion detection part 20 and the intermediate frame generation part 30, respectively, and is configured so as to include a frame memory.

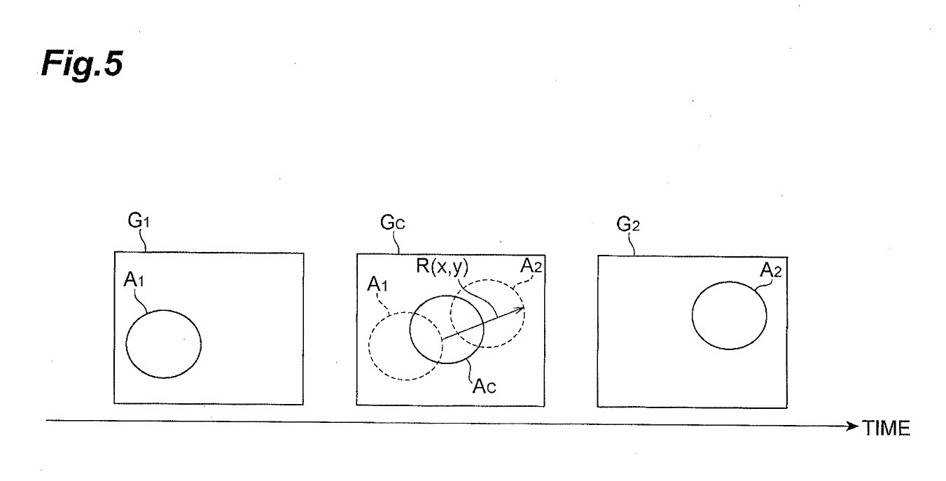

The motion detection part 20 detects a motion (vector R (x, y)) of an image of a second frame (image data in a region A₂) with respect to an image of a first frame (image data in a region A₁) based on image data G₁ of the first frame to be output from the delay part 10 and image data G₂ of the second frame to be input to the delay part 20, and outputs the detection result to the intermediate frame generation part 30. When a two-dimensional coordinate system is set by specifying an x axis in the horizontal direction of the frame and y axis in the vertical direction, the vector R (x, y) has a direction (x, y) and a distance R=(x²+y²)^{1/2} with the origin of the vector being assumed at coordinates (0, 0) (refer to FIG. 5). The second frame is a frame that follows the first frame.

As an algorithm of motion detection by the motion detection part 20, a matching method is used. That is, the motion detection part 20 determines whether or not image data in a certain region A₁ in the image of the first frame coincides with image data in some region in the image of the second frame and when the image data coincides with the region A₂ in the image of the second frame, a direction of the motion from the region A₁ to the region A₂ and a distance between them are detected in units of pixels. When one pixel A₁ (x₁, y₁) of the edge in the region A₁ moves to one pixel A₂ (x₂, y₂) of the corresponding edge in the region A₂, the vector R that represents the direction of movement and the distance between the two pixels is given as R (x, y)=A₂ (x₂, y₂)−A₁ (x₁, y₁)=R (x₂−x₁, y₂−y₁).

The intermediate frame generation part 30 generates image data G_{c} of the intermediate frame based on the image data G₁ , G₂ of the first frame and the second frame, respectively, when the motion detection part 20 detects that the edge in the image (image in the region A₂) of the second frame has moved a distance corresponding to two or more pixels with respect to the edge (the contour of a circle in the case of a circular image as shown in FIG. 5) in the image (image in the region A₁) of the first frame, and outputs the image data G_{C} of the intermediate frame to the output part 40. When a separation between pixels along the direction of x axis is assumed to be Lx and a separation between pixels along the direction of y axis is assumed to be Ly, if (x₂−x₁)≧2 Lx is satisfied, or (y₂−y₁)≧2 Ly is satisfied, it is determined that one pixel of the edge has moved a distance corresponding to two or more pixels. The edge in the image of the intermediate frame is located between the edges corresponding to each other in the images of the first frame and the second frame, respectively. One pixel in a region A_{C} of the intermediate frame exists at the middle point (x₁+(x₂−x₁)/2, y₁+(y₂−y₁)/2) on a line segment that connects the position of one corresponding pixel in the region A₁ and the position of one pixel in the region A₂. In the rest of the region outside the region A_{C} of the image data G_{C} of the intermediate frame, for example, the image of the first frame, from which the pixel group in the region A₁ is excluded, and the image of the second frame, from which the pixel group in the region A₂ is excluded, are added for each pixel, and a pixel group can be used, which includes pixels the addition value of which exceeds a threshold multiple (for example, 1.5 times) of the luminance of each pixel in the second frame from which the pixel group in the region A₂ is excluded, and the luminance of which is halved, however, in addition to this, publicly-known image processing methods can be used.

The output part 40 inserts the image data G_{C} of the intermediate frame before the image data G₂ of the second frame and outputs the data sequentially to the liquid crystal display device 2.

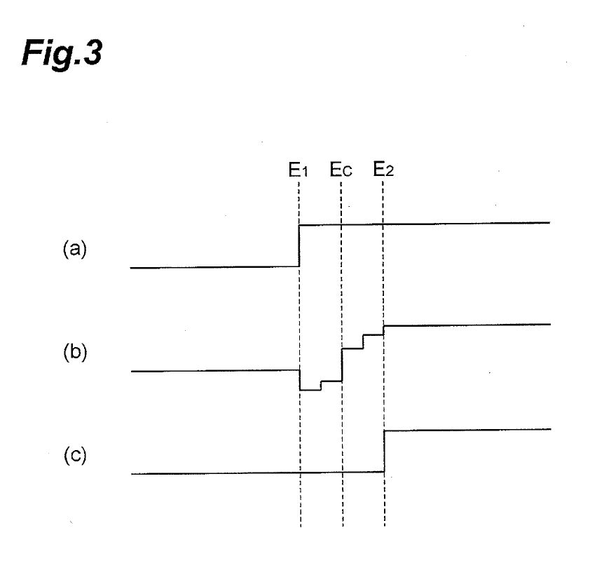

FIG. 2 and FIG. 3 are each a diagram for describing image data of an intermediate frame generated by the intermediate frame generation part 30 included in the image signal processing device 1 according to the present embodiment. The transverse axis in each of FIGS. 2(a) to 2(c) and FIGS. 3(a) to 3(c) indicates the pixel position on a certain line (for example, x axis) in an image of a frame. Each of FIG. 2(a) and FIG. 3(a) shows a distribution of image data (luminance) on the line of the first frame, each of FIG. 2(b) and FIG. 3(b) shows a distribution of image data (luminance) on the line of an intermediate frame, and each of FIG. 2(c) and FIG. 3(c) shows a distribution of image data (luminance) on the line of the second frame.

As shown in each of FIGS. 2(a) to 2(c) and FIGS. 3(a) to 3(c), it is assumed that the display image on the line has moved to the right and an edge E₂ in the image of the second frame is located to the right with respect to an edge E₁ in the image of the first frame. Further, an edge E_{C} in the image of the intermediate frame is at the middle position (for example, (x₁+(x₂−x₁)/2, y₁+(y₂−y₁)/2) between the edges E₁ E₂ corresponding to each other in the images of the first frame and the second frame, respectively.

In the example shown in FIG. 2, as shown in FIG. 2(a), in the image of the first frame, the image data of the pixel to the left side of the edge E₁ is larger than the image data of the pixel to the right side of the edge E₁. Further, as shown in FIG. 2(c), in the image of the second frame also, the image data of the pixel to the left side of the edge E₂ is larger than the image data of the pixel to the right side of the edge E₂.

That is, as to the pixel between the edge E₁ in the image of the first frame and the edge E₂ in the image of the second frame, the image data of the second frame is larger than the image data of the first frame.

In this case, as shown in FIG. 2(b), as to the pixel between the edge E_{C} in the image of the intermediate frame and the edge E₁ in the image of the first frame, the image data of the intermediate frame is made larger than the image data of the second frame as shown schematically. Between the edge E₁ and the edge E_{C}, there is a change in luminance in multiple steps in the figure. Further, as to the pixel between the E_{C} in the image of the intermediate frame and the edge E₂ in the image of the second frame, the image data of the intermediate frame is made to have a value between the image data of the first frame and the image data of the second frame, as shown schematically, however, the image data of the intermediate frame may have the same value as the image data of the first frame. Between the edge E_{C} and the edge E₂, there is a change in luminance in multiple steps in the figure.

In the example shown in FIG. 3, as shown in FIG. 3(a), in the image of the first frame, the image data of the pixel to the left side of the edge E₁ is smaller than the image data of the pixel to the right side of the edge E₁. Further, as shown in FIG. 3(c), in the image of the second frame also, the image data of the pixel to the left side of the edge E₂ is smaller than the image data of the pixel to the right side of the edge E₂. That is, as to the pixel between the edge E₁ in the image of the first frame and the edge E₂ in the image of the second frame, the image data of the second frame is smaller than the image data of the first frame.

In this case, as shown in FIG. 3(b), as to the pixel between the edge E_{C} in the image of the intermediate frame and the edge E₁ in the image of the first frame, the image data of the intermediate frame is made smaller than the image data of the second frame. Between the edge E₁ and the edge E_{C}, there is a change in luminance in multiple steps in the figure. Further, as to the pixel between the edge E_{C} in the image of the intermediate frame and the edge E₂ in the image of the second frame, the image data of the intermediate frame is made to have a value between the image data of the first frame and the image data of the second frame, as shown schematically, however, the image data of the intermediate frame may have the same value as the image data of the first frame. Between the edge E_{C} and the edge B₂, there is a change in luminance in multiple steps in the figure.

When the motion detection part 20 detects that the edge E₂ in the image of the second frame has moved a distance corresponding to three or more pixels with respect to the E₁ in the image of the frame 1, it is preferable to vary the image of the intermediate frame in multiple steps or vary for each pixel between the edge E_{C} in the image of the intermediate frame and the edge E₁ in the image of the first frame, or between the edge E_{C} in the image of the intermediate frame and the edge E₂ in the image of the second frame as shown in FIG. 2(b) and FIG. 3(b), respectively. At this time, it is preferable for the image data of the intermediate frame to decrease stepwise from the edge E₁ to the edge E₂ (FIG. 2(b)) or to increase stepwise (FIG. 3(b)). In FIG. 2(b) and FIG. 3(b), respectively, the image data of the intermediate frame is divided into two steps between the edge E_{C} and the edge E₁, and the image data of the intermediate frame is divided into two steps between the edge E_{C} and the edge B₂.

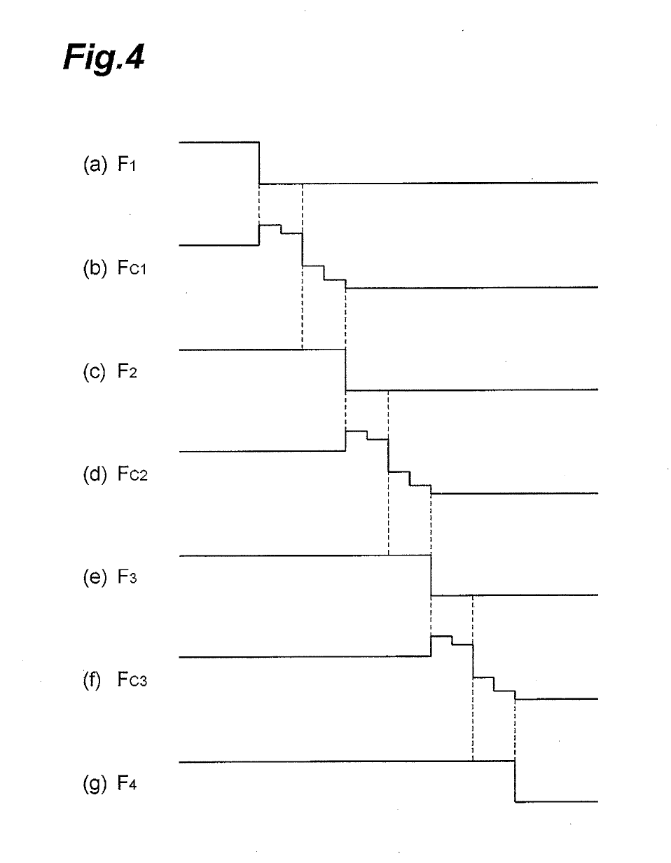

FIG. 4 is a diagram showing image data of each frame of an image signal output from the image signal processing device 1 and input to the liquid crystal display device 2 according to the present embodiment. The transverse axis in FIGS. 4(a) to 4(g) represents the pixel position on a certain line in an image of a frame. FIGS. 4(a), 4(c), 4(e) and 4(g) each show a distribution of image data of each of four successive frames F₁ to F₄ of the image signal input to the image signal processing device 1. FIGS. 4(b), 4(d) and 4(f) each show a distribution of image data of three intermediate frames F_{C1} to F_{C3} generated by the intermediate frame generation part 30 included in the image signal processing device 1.

The image data of the intermediate frame F_{C1} is generated by the intermediate frame generation part 30 based on the image data of the frame F₁ and the frame F₂, respectively, as that having the relationship described in FIG. 2. The image data of the intermediate frame F_{C2} is generated by the intermediate frame generation part 30 based on the image data of the frame F₂ and the frame F₃, respectively, as that having the relationship described in FIG. 2. Further, the image data of the intermediate frame F_{C3} is generated by the intermediate frame generation part 30 based on the image data of the frame F₃ and the frame F₄, respectively, as that having the relationship described in FIG. 2.

From the output part 40, image data is output sequentially in order of F₁, F_{C1}, F₂, F_{C2}, F₃, F_{C3}, F₄ . . . , and input to the liquid crystal display device 2 in this order. Consequently, the frame rate of the image signal output from the image signal processing device 1 and input to the liquid crystal display device 2 is made to be twice the frame rate of the image signal input to the image signal processing device 1.

On the screen of the liquid crystal display device 2, the image in accordance with the image data of each frame is displayed in order of F₁, F_{C1}, F₂, F_{C2}, F₃, F_{C3}, F₄, . . . For example, the display of the image of the frame F₁ is held until a display of the image of the next frame F_{C1} is specified. The display of the next frame F_{C1} is held until a display of the image of the next frame F₂ is specified. In this manner, on the screen of the liquid crystal display device 2, each image of the frames F₁, F_{C1}, F₂, F_{C2}, F₃, F_{C3}, F₄, is displayed sequentially for a period of time corresponding to one frame.

The edge E_{C} of each intermediate frame F_{Cn} generated by the intermediate frame generation part 30 and input to the liquid crystal display device 2 exists between the edges E₁ and E₂ of the frames Fₙ and Fₙ₊₁ before and after that frame. Further, the image data of the intermediate frame F_{Cn} between the edges E₁ and E₂ of the frames Fₙ and Fₙ₊₁, respectively, is that of the intermediate image of each image of the frames Fₙ and Fₙ₊₁, respectively, to which the overdrive technique has been applied with respect to the motion of the image. Here, n is an arbitrary integer. Consequently, in the liquid crystal display device 2 to which the image signal output from the image signal processing device 1 according to the present embodiment is input, the actual display value is made to reach the target display value quickly and the problem that the response is slow is solved and at the same time, an intermediate frame is used, and therefore, the visual sense of a viewer who is watching a motion picture displayed is enabled to easily follow the change in image, and therefore, the problem resulting from the visual characteristics of a viewer who is watching a motion picture can also be solved.

1. An image signal processing device that outputs an image signal to a liquid crystal display device after processing image data of each frame of the image signal, comprising:
a delay part to which image data of each frame of the image signal is input, and which outputs the image data after delaying the image data by a period of time corresponding to one frame;
a motion detection part that detects the motion of an image of a second frame with respect to the image of a first frame based on the image data of the first frame to be output from the delay part and the image data of the second frame to be input to the delay part;
an intermediate frame generation part that generates image data of an intermediate frame based on the image data of the first frame and the second frame, respectively, when the movement detection part detects that an edge in the image of the second frame has moved a distance corresponding to two more pixels with respect to an edge in the image of the first frame; and
an output part that inserts the image data of the intermediate frame before the image data of the second frame and outputs the image data sequentially to the liquid crystal display device, wherein:
the intermediate frame generation part:
positions the edge in the image of the intermediate frame between the edges corresponding to each other in the images of the first frame and the second frame, respectively;
makes the image data of the intermediate frame larger than the image data of the second frame as to the pixel between the edge in the image of the intermediate frame and the edge in the image of the first frame when the image data of the second frame is larger than the image data of the first frame as to the pixel between the edge in the image of the first frame and the edge in the image of the second frame; and
makes the image data of the intermediate frame smaller than the image data of the second frame as to the pixel between the edge in the image of the intermediate frame and the edge in the image of the first frame when the image data of the second frame is smaller than the image data of the first frame as to the pixel between the edge in the image of the first frame and the edge in the image of the second frame.

2. The image signal processing device according to claim 1, wherein
the intermediate frame generation part makes the image data of the intermediate frame have a value between the image data of the first frame and the image data of the second frame as to the pixel between the edge in the image of the intermediate frame and the edge in the image of the second frame.

3. The image signal processing device according to claim 1, wherein
the intermediate frame generation part varies the image data of the intermediate frame in multiple steps between the edge in the image of the intermediate frame and the edge in the image of the first frame, or between the edge in the image of the intermediate frame and the edge in the image of the second frame when the movement detection part detects that the edge in the image of the second frame has moved a distance corresponding to three or more pixels with respect to the edge in the image of the first frame.
